(19) United States
(12) Patent Application Publication
(10) Pub. No.: US 2018/0346297 A1
(43) Pub. Date: Dec. 6, 2018

(54) CABLE WINCH FOR AN AIRCRAFT OR VEHICLE, AND METHOD FOR CHECKING A CABLE WINCH FOR AN AIRCRAFT OR VEHICLE

(71) Applicant: JENOPTIK Advanced Systems GmbH, Wedel (DE)

(72) Inventors: Joachim SCHMIDT, Tornesch (DE); Ralf FRIEDERICHS, Hamburg (DE)

(73) Assignee: JENOPTIK Advanced Systems GmbH, Wedel (DE)

(21) Appl. No.: 15/750,666

(22) PCT Filed: Aug. 5, 2016
(86) PCT No.: PCT/EP2016/068772

§ 371 Date: Feb. 6, 2018

(30) Foreign Application Priority Data
Aug. 6, 2015 (DE) 10 2015 010 174.9

(51) Int. Cl. B66D 3/26; B66D 1/54; B66D 1/74; B66D 1/46

(52) U.S. Cl. CPC B66D 3/26; B66D 1/54; B66D 2700/0141; B66D 1/46; B66D 1/741

(57) ABSTRACT

The invention relates to a cable winch (100) for an aircraft or vehicle. The cable winch (100) has a central module (110), which can be or is attached to the aircraft or vehicle. The central module (110) is shaped in such a way that the central module can he or is mechanically connected to at least one further module (120, 130, 150, 160) of the cable winch (100) in a manually detachable manner by using at least one fastening device. The cable winch (100) also has a capstan drive module (120) for drawing a cable into the cable winch (100) and for letting the cable out of the cable winch (100). The capstan drive module (120) is shaped in such a way that the capstan drive module can be or is mechanically connected to the central module (110) in a manually detachable manner by using the at least one fastening device. The cable winch (100) also has a cable-winding module (130) for holding the cable by winding and unwinding the cable. The cable-winding module (130) is shaped in such a way that the cable-winding module can be or is mechanically connected to the central module (110) in a manually detachable manner by using the at least one fastening device.

This nonprovisional application is a National Stage of International Application No. PCT/EP2016/068772, which was filed on Aug. 5, 2016, and which claims priority to German Patent Application No. 10 2015 010 174.9, which was filed in Germany on Aug. 6, 2015, and which are both herein incorporated by reference.

### BACKGROUND OF THE INVENTION

### Field of the Invention

The present invention relates to a cable winch for an aircraft or vehicle, to a method for checking a cable winch for an aircraft or vehicle, to a corresponding apparatus and to a corresponding computer program product.

### Description of the Background Art

Some cable winches, e.g. electric rescue winches, can have a capstan drive and a cable drum for winding and unwinding a winch cable. When using a rescue winch in a helicopter, it is possible, in particular, for all the components of a rescue winch to be mounted centrally on a “boom” or “frame” of a helicopter.

DE 10 2012 013 527 A1 relates to an electric cable drum as a main component of an electric capstan, which can be used as a rescue winch on helicopters.

In the case of winches, especially rescue winches, in accordance with the current prior art, a repair in the event of a fault is often possible only after removing the entire winch from an aircraft or a vehicle in a recognized repair shop. It is therefore, in particular, an object of the present invention to enable a winch operator to carry out a necessary repair at module level themselves on the aircraft or vehicle and to issue the necessary re-approval for operation themselves. This procedure is increasingly demanded by winch operators in order to reduce both repair time and costs.

### SUMMARY OF THE INVENTION

Given this background situation, the present invention presents a cable winch for an aircraft or a vehicle, a method for checking a cable winch for an aircraft or vehicle, a corresponding apparatus and a corresponding computer program product in accordance with the main claims. Advantageous embodiments will be found in the respective dependent claims and the following description.

According to embodiments of the present invention, it is possible, in particular, to provide a modular construction of a cable winch, e.g. an electric rescue winch. In other words, a cable winch, e.g. an electric rescue winch for aircraft or vehicles, can be provided with a modular construction. In this case, it is possible, in particular, for the modules to be embodied in such a way that they can be attached to one another so as to be removable individually for servicing and maintenance or exchange. Integrated fault diagnostics, for example, also makes it possible to implement removal and reinstallation only of those modules which may be faulty.

In particular, it is possible, according to embodiments of the present invention, to enable a faulty winch to be repaired and recertified on the aircraft or vehicle, in particular on a helicopter, in the majority of cases, making it possible to reduce effort and thus servicing costs compared with exchange of a complete winch. It is likewise possible, for example, to enable a user to test and recertify the cable winch for themselves. It is thus not necessary, in particular, to remove the entire winch from the aircraft or vehicle and send it to customer services for repair and subsequent recertification in order to exchange faulty components or modules, for example. On the contrary, a faulty module can be exchanged or repaired selectively. For example, a faulty module can be replaced with a repaired or new module by swapping in a repair shop or can be held in storage by the user as a low-cost replacement module.

It is thus possible to increase the availability of the aircraft or vehicle, to reduce servicing costs and to shorten servicing times or downtimes. In particular, it is possible to carry out a repair of the cable winch on the aircraft or vehicle. According to embodiments of the present invention, it is therefore possible, for example, to reduce servicing outlay for a user. It is possible here, in particular, to reduce “DMCs” (Direct Maintenance Costs).

A cable winch for an aircraft or vehicle is presented, wherein the cable winch has the following features:

a central module, which can be or is attached to the aircraft or vehicle, wherein the central module is shaped in such a way that the central module can be or is mechanically connected to at least one further module of the cable winch in a manually detachable manner by using at least one fastening device;

a capstan drive module for drawing a cable into the cable winch and for letting the cable out of the cable winch, wherein the capstan drive module is shaped in such a way that the capstan drive module can be or is mechanically connected to the central module in a manually detachable manner by using the at least one fastening device; and

a cable-winding module for holding the cable by winding and unwinding the cable, wherein the cable-winding module is shaped in such a way that the cable-winding module can be or is mechanically connected to the central module in a manually detachable manner by using the at least one fastening device.

The cable winch can be embodied as an electric cable winch. In this case, the cable winch can be used as a rescue winch or the like. The cable winch can be mountable or mounted in the aircraft or vehicle, e.g. on an aerial vehicle, in particular on a helicopter. The cable winch module can have a cable drum. In a mounted state of the cable winch, the capstan drive module can be arranged between the cable-winding module and a cable entry section of the cable winch in relation to a cable running direction within the cable winch.

The central module can have minimum dimensions (W*H*D) of 10*15*10 cm and maximum dimensions of 30*50*30 cm. As a particular preference, the central module can have a size of 21*36*17 cm.

The cable-winding module can have minimum dimensions (W*H*D) of 10*15*10 cm and maximum dimensions of 30*50*30 cm. As a particular preference, the cable-winding module can have a size of 23*27*17 cm.

The capstan drive module can have minimum dimensions (W*H*D) of 10*15*10 cm and maximum dimensions of 30*50*30 cm. As a particular preference, the capstan drive module can have a size of 23*29*20 cm.

According to one embodiment, the central module and the capstan drive module can be shaped in such a way that the central module and the capstan drive module can be or are connected positively to one another. In this case, the central module and the cable-winding module can be shaped in such a way that the central module and the cable-winding module can be or are connected positively to one another. Such an embodiment has the advantage that the modules can be fastened to one another in a stable and secure manner, wherein cable forces can be reliably absorbed.

Moreover, the at least one fastening device can have quick fastening means for quick connection of the modules. Such an embodiment offers the advantage that quick mounting and removal of the modules is made possible.

In particular, it is possible for the central module to be capable of being or to be arranged between the capstan drive module and a cable-winding module. In this case, there can be a possibility of passing a cable of the cable winch at least once through the central module. Such an embodiment offers the advantage that these three modules can be connected to form a stable unit.

According to one embodiment, the central module can have at least one cable-guiding section, which can be designed to guide a cable of the cable winch in at least one cable channel through the central module. In this case, the central module can have a cable entry section, in which the cable can enter the cable winch and additionally or alternatively emerge from the cable winch. The cable-guiding section of the central module can also have at least one cable pulley or the like. Such an embodiment offers the advantage that a cable or winch cable can be guided reliably between the capstan drive module and the cable-winding module. Moreover, the subassembly comprising the central module, the capstan drive module and cable-winding module can be implemented in a space-saving manner.

The cable winch can furthermore have a load hook module, which can be shaped in such a way that the load hook module can be or is mechanically connected to a cable of the cable winch in a manually detachable manner. In this case, the load hook module can be designed in such a way that the load hook module can be connected or is connected positively to a free end of the cable. Such an embodiment offers the advantage that the load hook of the cable winch can also be removed and reattached in an uncomplicated manner when required.

Moreover, the cable winch can have a braking resistance module, which can be shaped in such a way that the braking resistance module can be or is mechanically connected to the central module in a manually detachable manner by using the at least one fastening device. In addition or as an alternative, it is possible for the braking resistance module to be capable of being or to be attached to the aircraft or vehicle. Such an embodiment offers the advantage that the braking resistance module can also be mounted, removed and remounted when required. The braking resistance module can convert into heat the electric energy produced in generator mode during the lowering mode of the cable winch if storage (recuperation) or feeding back into the onboard electrical system of the aircraft or vehicle is not possible.

Moreover, the cable winch can have a control module, which can be shaped in such a way that the control module can be or is mechanically connected to the central module in a manually detachable manner by using the at least one fastening device. In addition or as an alternative, it is possible for the control module to be capable of being or to be attached to the aircraft or vehicle. The control module can be designed to control operation of the cable winch. Such an embodiment offers the advantage that even the electronic control unit of the cable winch can be exchanged separately from the other modules.

In this case, the control module can be designed to carry out a fault diagnosis on the modules of the cable winch. Such an embodiment offers the advantage that a fault diagnosis can be carried out at module level, wherein a fault diagnosis can be simplified for a user and a faulty module can be reliably indicated. By means of this fault diagnosis, all the essential electric and electronic components of the individual modules are checked for correct behavior. In the event of a fault, a fault entry can be written to a memory. This entry can be read out during fault diagnosis in order then to exchange the module in which the faulty behavior/failure has been detected. Furthermore, it is possible to start a fault diagnosis which records which function is faulty in a fault log. If mechanical components fail, the fault log can assist fault diagnosis. After the exchange of a module which has been recognized as faulty, it is possible to call a function to confirm successful repair.

In particular, it is possible for the modules that can be or are connected to the central module to be capable of being or to be connected to the central module in such a way that they can be detached manually from the central module independently of one another. In other words, the modules which can be or are connected to the central module can be capable of being or can be connected to the central module in such a way that said modules can be manually detached individually from the central module. Such an embodiment offers the advantage that maintenance times and thus also maintenance costs can be reduced.

A method for checking a cable winch for an aircraft or vehicle is also presented, wherein the method has the following step:

carrying out a fault diagnosis in respect of the cable winch, wherein the cable winch has a central module, which can be or is attached to the aircraft or vehicle, and at least one further module, wherein the central module and the at least one further module are shaped in such a way that the central module and the at least one further module can be or are mechanically connected to one another in a manually detachable manner by using at least one fastening device, wherein the step of carrying out the fault diagnosis is carried out in order to detect a fault and to determine whether the detected fault has occurred in the central module or the at least one further module.

Here, the method can advantageously be carried out in conjunction with or using one embodiment of the abovementioned cable winch. In particular, the method can advantageously be carried out in conjunction with or using the control module of one embodiment of the abovementioned cable winch. Normally, the step of carrying out fault diagnosis can be carried out using a preset value and additionally or alternatively in response to a signal.

According to one embodiment, the method can also have a step of reading in a test assignment signal, which represents a command for carrying out the fault diagnosis, from an interface with a user input device. The interface can be embodied as a wired or wireless interface, for example, by means of which it is possible for the user input device to be capable of being or to be connected to the cable winch in a manner which allows signal transmission. The user input device can be arranged outside, separately from and additionally or alternatively spaced apart from the cable winch. Such an embodiment offers the advantage that the fault diagnosis can be initiated in a reliable and simple manner.

According to one embodiment can have a step of making available a test result signal, which represents a result of the fault diagnosis, to an interface with a user input device. In particular, the test result signal can represent information on which module of the cable winch is affected by a fault. The interface can be embodied as a wired or wireless interface, for example, by means of which it is possible for the user input device to be capable of being or to be connected to the cable winch in a manner which allows signal transmission. The user input device can be arranged outside, separately from and additionally or alternatively spaced apart from the cable winch. Such an embodiment offers the advantage that it is possible to indicate which module is faulty in a reliable and simple manner.

An apparatus which is designed to carry out, control and/or implement the steps of a variant of a method presented here in corresponding devices is furthermore presented. By means of this variant embodiment of the invention in the form of an apparatus too, the object underlying the invention can be achieved quickly and efficiently.

The apparatus can be designed to read in input signals and to determine and make available output signals using the input signals. An input signal can represent a sensor signal that can be read in via an input interface of the apparatus, for example. An output signal can represent a control signal or a data signal, which can be made available at an output interface of the apparatus. The apparatus can be designed to determine the output signals using a processing algorithm implemented in the form of hardware or software. For example, the apparatus can comprise a logic circuit, an integrated circuit or a software module for this purpose and can be implemented as a discrete component or included in a discrete component, for example.

The apparatus can be embodied as part of the control module of the cable winch. Thus, the control module of the cable winch can have the apparatus. Moreover, the control module of the cable winch can thus be designed to carry out, control and/or implement the steps of a variant of a method presented here in corresponding devices.

A computer program product or computer program comprising program code which can be stored on a machine-readable carrier or storage medium, such as a semiconductor memory, a hard disk memory or an optical memory is also advantageous. If the program product or program is carried out on a computer or an apparatus, the program product or program can be used to carry out, implement and/or control the steps of the method according to one of the embodiments described above.

As an alternative, the cable winch can also be embodied by integrating all the modules apart from the load hook module into a supporting frame. It is possible for the supporting frame to be capable of being or to be fastened to the aircraft or vehicle by quick fastening means. In this case, it is possible for the cable winch to be capable of being or to be coupled to the aircraft or vehicle in a simple manner.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic perspective illustration of a cable winch according to one illustrative embodiment; and

FIG. 2 shows a flow diagram of a method for checking according to one illustrative embodiment.

### DETAILED DESCRIPTION

Before illustrative embodiments are discussed, basic principles and background information relating to the present invention will first of all be presented. In the case of electric cable winches, especially rescue winches, a capstan drive and a cable drum for winding and unwinding the winch cable are provided, for example. Here, the capstan drive assumes the task of transmitting the forces caused by a load on the hook, for example, wherein the cable drum winds and unwinds the cable with a relatively low tensile force.

In the following description of advantageous illustrative embodiments of the present invention, identical or similar reference signs are used for the elements with a similar action illustrated in the various figures, wherein repeated description of these elements is dispensed with.

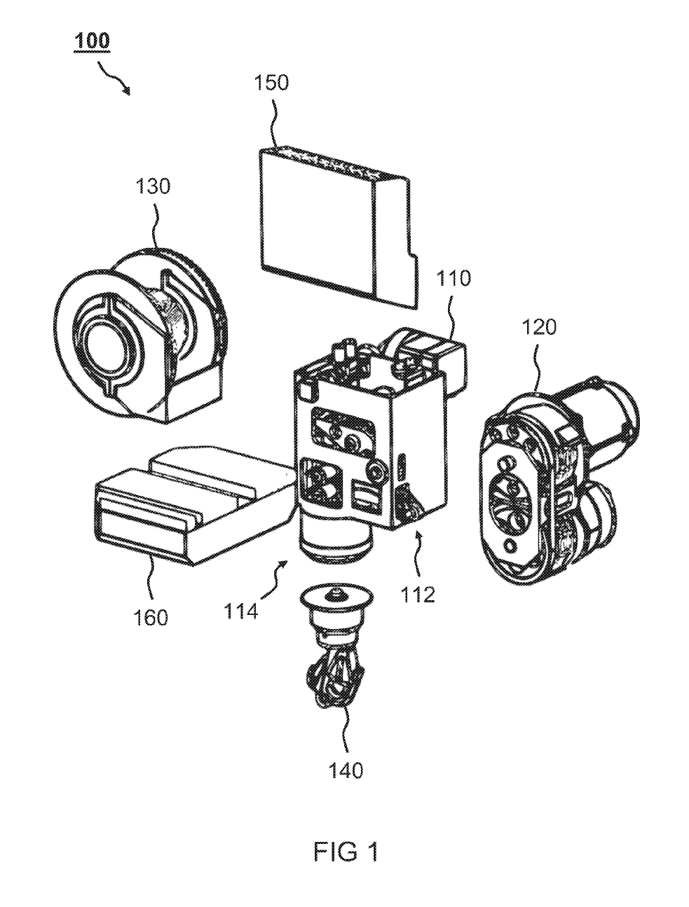

FIG. 1 shows a schematic perspective illustration of a cable winch 100 according to one illustrative embodiment. In this case, the cable winch 100 is shown in an exploded view in relation to a module plane. The cable winch 100 is provided or designed for mounting on an aircraft or vehicle, in particular for mounting on a helicopter. According to the illustrative embodiment shown in FIG. 1, the cable winch 100 is an electric rescue winch, in particular for helicopters. In the exploded illustration in FIG. 1, the cable winch 100 is shown without an associated cable or winch cable, purely for reasons of illustration.

The cable winch 100 is of modular construction. In this case, the cable winch 100 has a central module 110. The central module 110 is designed or shaped in such a way that the central module is or will be attached to a supporting structure of the aircraft or vehicle. The central module 110 is also embodied as a mounting base for further modules of the cable winch 100. In this case, the central module 110 is shaped in such a way that the central module is or will be mechanically connected to at least one further module 110 of the cable winch in a manually detachable manner by using at least one fastening device.

The cable winch 100 furthermore has a “capstan drive module” 120. The capstan drive module 120 is designed to draw in a winch cable of the cable winch 100 into the cable winch 100 and to lift said cable out of the cable winch 100. The capstan drive module 120 is also shaped in such a way that the capstan drive module can be or is or will be mechanically connected to the central module 110 in a manually detachable manner by using at least one fastening device. Thus, the capstan drive module 120 and the central module 110 are embodied in such a way that they can be mechanically connected to one another in a manually detachable manner. In particular, the central module 110 and the capstan drive module 120 are shaped in such a way here that the central module and the capstan drive module can be or are connected positively to one another.

The cable winch 100 also has a cable-winding module 130. In this case, the cable-winding module 130 has a cable drum, for example. The cable-winding module 130 is designed to hold a winch cable of the cable winch 100 by winding and unwinding the cable. The cable-winding module 130 is also shaped in such a way that the cable-winding module can be or is or will be mechanically connected to the central module 110 in a manually detachable manner by using at least one fastening device. Thus, the cable-winding module 130 and the central module 110 are embodied in such a way here that they can be mechanically connected to one another in a manually detachable manner. In particular, the central module 110 and cable-winding module 130 are shaped in such a way that the central module and the cable-winding module can be or are connected positively to one another.

According to the illustrative embodiment shown in FIG. 1, the central module 110 is arranged between the capstan drive module 120 and the cable-winding module 130. In a state in which they are mechanically connected to one another, the central module 110, the capstan drive module 120 and the cable-winding module 130 form a subunit of the cable winch 100.

The central module 110 has at least one cable-guiding section 112. The at least one cable-guiding section 112 is designed to guide a cable of the cable winch 100 in at least one cable channel through the central module 110. In particular, a winch cable of the cable winch 110 can be guided through the central module 110 by means of the at least one cable-guiding section 112 in at least one cable channel between the capstan drive module 120 and the cable-winding module 130. In this case, the cable-guiding section 112 can have at least one cable pulley, deflection pulley, unseating prevention device and/or the like.

The central module 110 furthermore has a cable entry section 114. In the cable entry section 114, the cable enters the cable winch 100 and leaves the cable winch 100. In other words, the cable entry section 114 is designed to act as a cable entry and cable exit of the cable winch 100.

In a mounted state of the cable winch 100, a cable or winch cable of the cable winch 100 extends along a cable path between the cable entry section 114 and the cable-winding module 130. When viewed from the cable entry section 114, the cable path extends along a first cable channel through the central module 110, from the central module 110 to the capstan drive module 120, from the capstan drive module 120 back to the central module 110, along a second cable channel through the central module 110 and from the central module 110 to the cable-winding module 130.

The cable winch 100 furthermore has a load hook module 140. The load hook module 140 is shaped in such a way that the load hook module can be or is or will be mechanically connected to a cable of the cable winch 100 in a manually detachable manner. In this case, the load hook module 140 can be fastened to a free end of the cable. In the exploded illustration in FIG. 1, the load hook module 140 is arranged adjacent to the central module 110, to be more precise adjacent to the cable entry section 114 of the central module 110.

Furthermore, the cable winch 100 has a braking resistance module 150. The braking resistance module 150 is shaped in such a way that the braking resistance module can be or is or will be mechanically connected to the central module 110 in a manually detachable manner by using at least one fastening device. In addition or as an alternative, the braking resistance module 150 can be shaped in such a way that the braking resistance module can be or is or will be attached to some other module of the cable winch 100 and/or to the aircraft or vehicle.

The cable winch 100 also has a control module 160 or controller 160. Here, the control module 160 is designed to control operation of the cable winch 100. The control module 160 is shaped in such a way that the control module can be or is or will be mechanically connected to the central module 110 in a manually detachable manner by using at least one fastening device. In addition or as an alternative, the control module 160 can be shaped in such a way that the control module can be or is or will be attached to some other module of the cable winch 100 and/or to the aircraft or vehicle.

According to one illustrative embodiment, the control module 160 is designed to carry out a fault diagnosis on the modules of the cable winch 100, i.e. on the central module 110, the capstan drive module 120, the cable-winding module 130, the braking resistance module 150 and the control module 160 itself.

According to one illustrative embodiment, the at least one fastening device can have quick fastening means for quick connection of the modules. In particular, the at least one fastening device can have quick fastening means for quickly connecting the central module 110 to the capstan drive module 120 and to the cable-winding module 130. As an option, the at least one fastening device can also have quick fastening means for quick mounting of the load hook module 140, the braking resistance module 150 and the control module 160.

In particular, according to the illustrative embodiment shown in FIG. 1, the cable winch 100 is embodied in a modular manner in such a way that the modules 120, 130, 150 and 160, which can be connected to the central module 110 or to some other module of the cable winch 100, can be removed manually from the cable winch 100 individually or independently of one another. Thus, particularly the modules 120, 130, 150 and 160, which can be connected to the central module 110, can be or are connected to the central module 110 in such a way that they can be detached manually from the central module 110 independently of one another.

In other words and by way of summary, the cable winch 100 or electric rescue winch 100 according to the illustrative embodiment shown in FIG. 1 is constructed, purely by way of example, from six modules 110, 120, 130, 140, 150 and 160 which can be removed and exchanged individually. This ensures that the cable winch 100 can be repaired and recertified within a short time. In order to allow easy exchangeability of individual modules, in particular the capstan drive module 120, the cable-winding module 130 and the load hook module 140, these are mounted by means of positive engagement on the central module 110 or, in the case of the load hook module 140, on the cable and are secured by means of quick fastening means. The controller 160 and the braking resistance module 150 are likewise designed for easy exchangeability but, in this case, positive engagement is not required since the forces transmitted are not usually large. Each exchangeable module 110, 120, 130, 140, 150 and 160 is independently testable and certifiable, and therefore the modules 110, 120, 130, 140, 150 and 160 can be produced and sold as spare parts in compliance with air transport regulations. In the event of a fault, these modules 110, 120, 130, 140, 150 and 160 can be repaired and recertified for reuse by an authorized servicing operation, for example.

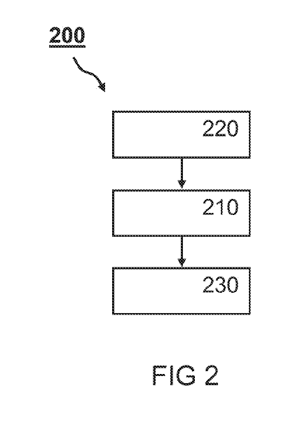

FIG. 2 shows a flow diagram of a method 200 for checking according to one illustrative embodiment. The method 200 can be carried out to check a cable winch for an aircraft or vehicle. In this case, the method 200 for checking can be carried out in conjunction with or using the cable winch in FIG. 1 or a similar cable winch.

In particular, the control module or controller of the cable winch in FIG. 1 is designed here to carry out, control and/or implement the steps of the method 200 for checking in corresponding devices or a corresponding apparatus.

The method 200 for checking has a step 210 of carrying out a fault diagnosis relating to the cable winch. Here, the cable winch that can be checked by carrying out the method 200 has a central module, which can be or is attached to the aircraft or vehicle, and at least one further module. The central module and the at least one further module are shaped in such a way that the central module and the at least one further module can be or are mechanically connected to one another in a manually detachable manner by using at least one fastening device. In this case, the step 210 of carrying out the fault diagnosis is carried out to detect a fault and to determine whether the detected fault has occurred in the central module or the at least one further module.

According to one illustrative embodiment, the method 200 for checking also has a step 220 of reading in a test assignment signal from an interface with a user input device. Here, the test assignment signal represents a command for carrying out the fault diagnosis. The user input device can be arranged outside the cable winch, for example. In the step 220 of reading in, the test assignment signal is read in via a wireless interface, for example. The step 220 of reading in can be carried out before the step 210 of carrying out the fault diagnosis. Moreover, the method 200 for checking according to one illustrative embodiment has a step 230 of making available a test result signal to the interface or to a further interface, in particular a wireless interface, with the user input device. Here, the test result signal represents a result of the fault diagnosis, in particular in the form of result data. The step 230 of making the result available can be carried out after the step 210 of carrying out the fault diagnosis.

According to one illustrative example, the step 210 of carrying out the fault diagnosis can be carried out at regular intervals using a preset value, for example. In addition or alternatively, the step 210 of carrying out the fault diagnosis can be carried out in response to a signal, e.g. a test assignment signal that has been read in.

In other words and by way of summary, a fault diagnosis at the module level is made possible, wherein the controller of the cable winch can have a test program or the like which assists fault diagnosis and can indicate a faulty module. An operator interface or user interface for servicing personnel can likewise be provided. This operator interface can be suitable for running on commercially available notebooks or tablets, for example, and can communicate with the controller of the cable winch by USB or by Wi-Fi.

The illustrative embodiments described and shown in the figures are chosen purely by way of example. Different illustrative embodiments can be combined with one another fully or in respect of individual features. It is also possible for one illustrative embodiment to be supplemented by features of another illustrative embodiment.

Furthermore, method steps according to the invention can be repeated and carried out in a sequence other than that described.

If an illustrative embodiment comprises an “and/or” conjunction between a first feature and a second feature, this should be read in such a way that the illustrative embodiment has both the first feature and the second feature according to one embodiment and either only the first feature or only the second feature according to another embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cable winch for an aircraft or vehicle, the cable winch comprising:
a central module, which can be or is attached to the aircraft or vehicle, wherein the central module is shaped in such a way that the central module can be or is mechanically connected to at least one further module of the cable winch in a manually detachable manner by using at least one fastening device;
a capstan drive module for drawing a cable into the cable winch and for letting the cable out of the cable winch, wherein the capstan drive module is shaped in such a way that the capstan drive module can be or is mechanically connected to the central module in a manually detachable manner by using the at least one fastening device; and
a cable-winding module for holding the cable by winding and unwinding the cable, wherein the cable-winding module is shaped in such a way that the cable-winding module can be or is mechanically connected to the central module in a manually detachable manner by using the at least one fastening device.

2. The cable winch as claimed in claim 1, wherein the central module and the capstan drive module are shaped in such a way that the central module and the capstan drive module can be or are connected positively to one another, wherein the central module and the cable-winding module are shaped in such a way that the central module and the cable-winding module can be or are connected positively to one another.

3. The cable winch as claimed in claim 1, wherein the at least one fastening device has quick fastening means for quick connection of the modules.

4. The cable winch as claimed in claim 1, wherein the central module can be or is arranged between the capstan drive module and the cable-winding module.

5. The cable winch as claimed in claim 1, wherein the central module has at least one cable-guiding section, which is designed to guide a cable of the cable winch in at least one cable channel through the central module, wherein the central module has a cable entry section, in which the cable enters the cable winch and/or emerges from the cable winch.

6. The cable winch as claimed in claim 1, further comprising a load hook module, which is shaped in such a way that the load hook module can be or is mechanically connected to a cable of the cable winch in a manually detachable manner.

7. The cable winch as claimed in claim 1, further comprising a braking resistance module, which is shaped in such a way that the braking resistance module can be or is mechanically connected to the central module in a manually detachable manner by using the at least one fastening device.

8. The cable winch as claimed in claim 1, further comprising a control module, which is shaped in such a way that the control module can be or is mechanically connected to the central module in a manually detachable manner by using the at least one fastening device.

9. The cable winch as claimed in claim 8, wherein the control module is designed to carry out a fault diagnosis on the modules of the cable winch.

10. The cable winch as claimed in claim 1, wherein the modules that can be or are connected to the central module can be or are connected to the central module in such a way that they can be detached manually from the central module independently of one another.

11. A method for checking a cable winch for an aircraft or vehicle, wherein the method has the following step:
carrying out a fault diagnosis in respect of the cable winch, wherein the cable winch has a central module, which can be or is attached to the aircraft or vehicle, and at least one further module, wherein the central module and the at least one further module are shaped in such a way that the central module and the at least one further module can be or are mechanically connected to one another in a manually detachable manner by using at least one fastening device, wherein the step of carrying out the fault diagnosis is carried out in order to detect a fault and to determine whether the detected fault has occurred in the central module or the at least one further module.

12. The method as claimed in claim 11, further comprising a step of reading in a test assignment signal, which represents a command for carrying out the fault diagnosis, from an interface with a user input device.

13. The method as claimed in claim 11, further comprising a step of making available a test result signal, which represents a result of the fault diagnosis, to an interface with a user input device.

14. An apparatus which is designed to carry out, control and/or implement the steps of a method as claimed in claim 11 in corresponding devices.

15. A computer program product comprising program code for carrying out a method as claimed in claim 11 when the program product is carried out on an apparatus.
